(19) United States
(12) Patent Application Publication
(10) Pub. No.: US 2017/0089720 A1
(43) Pub. Date: Mar. 30, 2017

(54) METHOD OF AND APPARATUS FOR SERVICE PROCESSING BASED ON NAVIGATION INFORMATION

(71) Applicant: Xiaomi Inc., Beijing (CN)

(72) Inventors: Pengfei Zhang, Beijing (CN); Yi Wang, Beijing (CN); Xiang Long, Beijing (CN); Erwei Huo, Beijing (CN)

(73) Assignee: Xiaomi Inc., Beijing (CN)

(21) Appl. No.: 15/278,904

(22) Filed: Sep. 28, 2016

(30) Foreign Application Priority Data
Sep. 29, 2015 (CN) 201510633741.8

(51) Int. Cl. G01C 21/36; H04L 29/08; G06Q 10/02; G01C 21/34

(52) U.S. Cl. CPC G01C 21/3682; G01C 21/3407; H04L 67/18; G01C 21/3691; G06Q 10/02

(57) ABSTRACT

Methods of and apparatuses for service processing based on navigation information are provided in the present disclosure. A method of service processing includes: obtaining, with a processor, the navigation information; determining, by a processor, a service related to the navigation information; and executing, by a processor, a pre-processing operation related to the service before arriving at a location for utilizing the service.

### CROSS-REFERENCE TO RELATED APPLICATION(S)

This application claims priority to and benefits of Chinese Patent Application Serial No. CN201510633741.8, filed with the State Intellectual Property Office of P. R. China on Sep. 29, 2015, the entirety of which is incorporated herein by reference.

### FIELD

The present disclosure relates to the terminal technology field, and more particularly to methods of, and apparatuses and electronic devices for, service processing based on navigation information.

### BACKGROUND

The statements in this section merely provide background information related to the present disclosure and may not constitute prior art.

Because a user may not be familiar with a route and may not know a road condition etc. while travelling outside, a navigation aid is often adopted, e.g. a mobile phone or a tablet PC installed with navigation software, or a specific navigator or other electronic devices.

In related art, navigation software may display maps on an electronic device, with information such as a current location of the user, a navigation route, road conditions in the neighborhood etc. shown in the map, and thus the information obtained by the user is only limited to “navigation”.

### SUMMARY

In order to solve problems in the related art, the present disclosure provides methods of, and apparatuses and electronic devices for, service processing based on navigation information. Services include activities that are performed by entities. Services also include the supply of or access to utilities, commodities, and activities. For example, business services include activities performed by businesses (e.g. provision of catering, provision of accommodations, provision of fuel, etc.), non-profit services include activities performed by public or private non-profit entities (e.g. provision of healthcare, provision of entertainment services, provision of public transportation, etc.). Services also include access to man-made or natural facilities or landmarks, etc. Services for the purposes of this disclosure are not however limited to these enumerated examples, and other types of services consistent with this disclosure will become apparent to one skilled in the art with the benefit of this disclosure.

According to embodiments of a first aspect of the present disclosure, a method of service processing based on navigation information is provided. The method may include obtaining, with a processor, the navigation information. The method may further include determining, with the processor, a service related to the navigation information. The method may further include executing, with the processor, a pre-processing operation related to the service before arriving at a location for utilizing the service.

According to embodiments of a second aspect of the present disclosure, an apparatus for service processing based on navigation information is provided. The apparatus may include a processor and a memory configured to store instructions executable by the processor. The processor may be configured to obtain the navigation information. The processor may be further configured to determine a service related to the navigation information. The processor may be further configured to execute a pre-processing operation related to the service before arriving at a location for utilizing the service.

According to embodiments of a third aspect of the present disclosure, an electronic device is provided in the present disclosure. The electronic device may include an apparatus for service processing based on navigation information. The apparatus for service processing based on navigation information may include a processor and a memory configured to store instructions executable by the processor. The processor may be configured to obtain the navigation information. The processor may be further configured to determine a service related to the navigation information. The processor may be further configured to execute a pre-processing operation related to the service before arriving at a location for utilizing the service.

It is to be understood that both the foregoing general description and the following detailed description are exemplary and explanatory only and are not restrictive of the present disclosure.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

The accompanying drawings, which are incorporated in and constitute a part of this specification, illustrate embodiments consistent with the disclosure and, together with the description, serve to explain the principles of the present disclosure.

FIG. 1 is a schematic diagram of a navigation interface in the related art.

FIG. 2 is a flow chart of a method of service processing based on navigation information according to an example embodiment.

FIG. 3 is a flow chart of a method of service processing based on navigation information according to an example embodiment.

FIGS. 4A-4B are schematic diagrams of an interface for obtaining navigation information according to an example embodiment.

FIG. 5 is a schematic diagram showing services based on a navigation route according to an example embodiment.

FIGS. 6A-6B are block diagrams showing services based on a navigation route and arriving time according to an example embodiment.

FIGS. 7-15 are block diagrams of an apparatus for service processing based on navigation information according to an example embodiment.

FIG. 16 is a schematic diagram of a device for service processing based on navigation information according to an example embodiment.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Example embodiments will be described in detail herein, and examples thereof are illustrated in accompanying drawings. Throughout the figures, corresponding reference numerals indicate like or corresponding parts and features, unless otherwise stated. Implementations described in the following exemplary embodiments do not represent all implementations consistent with the present disclosure. Instead, they are only examples of devices and methods consistent with some aspects of the present disclosure detailed in the appended claims.

Reference throughout this specification to “one embodiment,” “an embodiment,” “exemplary embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in an exemplary embodiment,” or the like in the singular or plural in various places throughout this specification are not necessarily all referring to the same embodiment. Furthermore, the particular features, structures, or characteristics in one or more embodiments may be combined in any suitable manner.

The terminology used in the description of the disclosure herein is for the purpose of describing particular examples only and is not intended to be limiting of the disclosure. As used in the description of the disclosure and the appended claims, the singular forms “a,” “an,” and “the” are intended to include the plural forms as well, unless the context clearly indicates otherwise. Also, as used in the description herein and throughout the claims that follow, the meaning of “in” includes “in” and “on” unless the context clearly dictates otherwise. It will also be understood that the term “and/or” as used herein refers to and encompasses any and all possible combinations of one or more of the associated listed items. It will be further understood that the terms “may include,” “including,” “comprises,” and/or “comprising,” when used in this specification, specify the presence of stated features, operations, elements, and/or components, but do not preclude the presence or addition of one or more other features, operations, elements, components, and/or groups thereof.

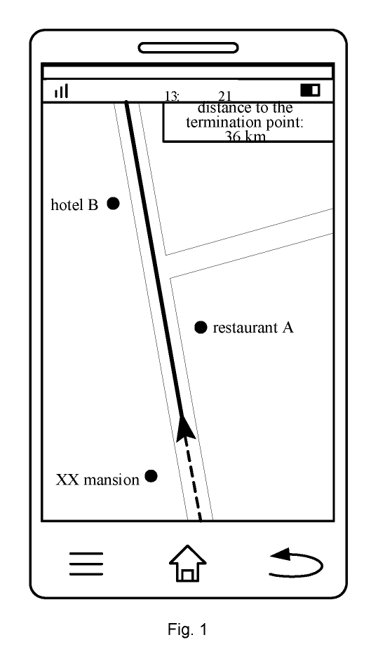

As shown in FIG. 1, in the related art, when a user executes a navigation operation via an electronic device, in order to make it convenient for the user to search for a walking or driving route, a map may be displayed on the electronic device, with information such as a current location of the user, a navigation route, and road conditions in the neighborhood shown on the map so as to realize the navigation.

Based on a Point of Interest (POI) retrieved from local storage or downloaded from a server by navigation software, the navigation software may indicate on the map POIs around the current location of the user, e.g. restaurant A, hotel B, and XX mansion, etc., as shown in FIG. 1, such that the user may execute operations like checking for options and making reservations.

However, navigation software in the related art may only be used to indicate the POIs around the current location of the user. This function is actually limited by the characteristics of the “navigation” operation itself, because the map is required to be displayed at a magnification level clearly showing the information (such as the road conditions) around the user in order to ensure a successful realization of the navigation operation. Unless the user actively regulates the map to show locations along the navigation route or at the termination point, e.g. by changing the map's magnification level or the area currently being displayed, it is hard for the user to execute operations like checking for options of and making reservations for POIs at corresponding locations. Unfortunately, these regulation operations may interrupt the navigation operations of the user, especially for a user who is driving, which may cause a high driving risk.

Therefore, the present disclosure may, based on an analysis of the navigation information, perform a pre-processing operation on a service related to the navigation information, without affecting the navigation operation, such that the above-described technical problem existing in the related art may be solved.

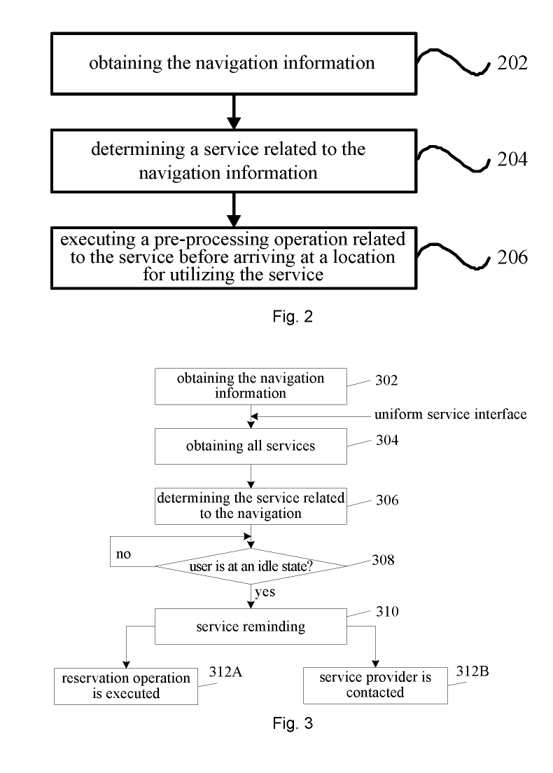

FIG. 2 is a flow chart of a method of service processing based on navigation information according to an example embodiment. The method of service processing shown in FIG. 2 is executed in an electronic device provided with navigation software, and may include steps as follows.

In step 202, the navigation information is obtained.

In step 204, a service related to the navigation information is determined.

In an embodiment, the navigation information includes a navigation route. Determining a service related to the navigation information may include choosing a service with a location for utilizing the service that is along the navigation route or at a termination point of the navigation route.

In an embodiment, the navigation information further includes, for a plurality of services, a respective pre-estimated time of arrival at a respective location for utilizing each service. Determining a service related to the navigation information may include choosing, from the plurality of services, a service with a respective location for utilizing the service that is along the navigation route or at the termination point of the navigation route, and for which a respective pre-estimated time of arrival at the respective location for utilizing the service is within a pre-determined service processing time period of the service.

The pre-estimated time may be related to at least one of a mode of transportation used by a user, status information of the mode of transportation, and a traffic condition.

In an embodiment, the navigation information further includes user attribute information in a preset dimension. Determining a service related to the navigation information may include choosing a service with a respective location for utilizing the service that is along the navigation route or at the termination point of the navigation route, and that satisfies a user requirement corresponding to the user attribute information.

The preset dimension may include at least one of a number of users, a user gender, a user age, or a user relationship.

In an embodiment, determining a service related to the navigation information includes obtaining all services via a pre-configured uniform service interface, and choosing, from all of the services, a service related to the navigation information.

In step 206, a pre-processing operation related to the service is executed before arriving at a location for utilizing the service.

In an embodiment, executing a pre-processing operation related to the service includes executing a reservation operation for the service according to the navigation information.

In an embodiment, executing a pre-processing operation related to the service includes sending a notification message to a service provider, in which the notification message includes the navigation information.

In an embodiment, the method of service processing further includes reminding a user of the service related to the navigation information. The method may further include determining, according to a received user selection instruction, whether or not to execute the pre-processing operation.

The method of service processing may further include determining whether the user is at a pre-determined idle status, and when the user is determined to be at the pre-determined idle status, reminding the user of the service related to the navigation information.

According to the above embodiments of the present disclosure, the present disclosure may predict potential service requirements for users by determining the service related to the navigation information. Meanwhile, subsequent operations of the user after arriving at the location for utilizing the service may be simplified by executing the pre-processing operations related to the service. Also, missing out on the opportunity to qualify for the service due to a long driving time may be avoided.

FIG. 3 is a flow chart of a method of service processing based on navigation information according to an example embodiment. The method of service processing shown in FIG. 3 is executed in an electronic device provided with navigation software, and may include steps as follows.

In step 302, the navigation information is obtained.

In the present embodiment, the electronic device may obtain the navigation information in any way, which is not limited to the examples in the present disclosure. Some examples are explained as follows.

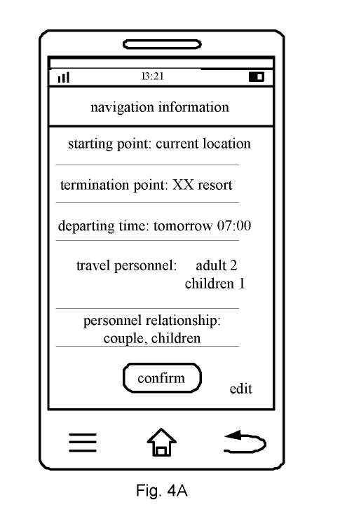

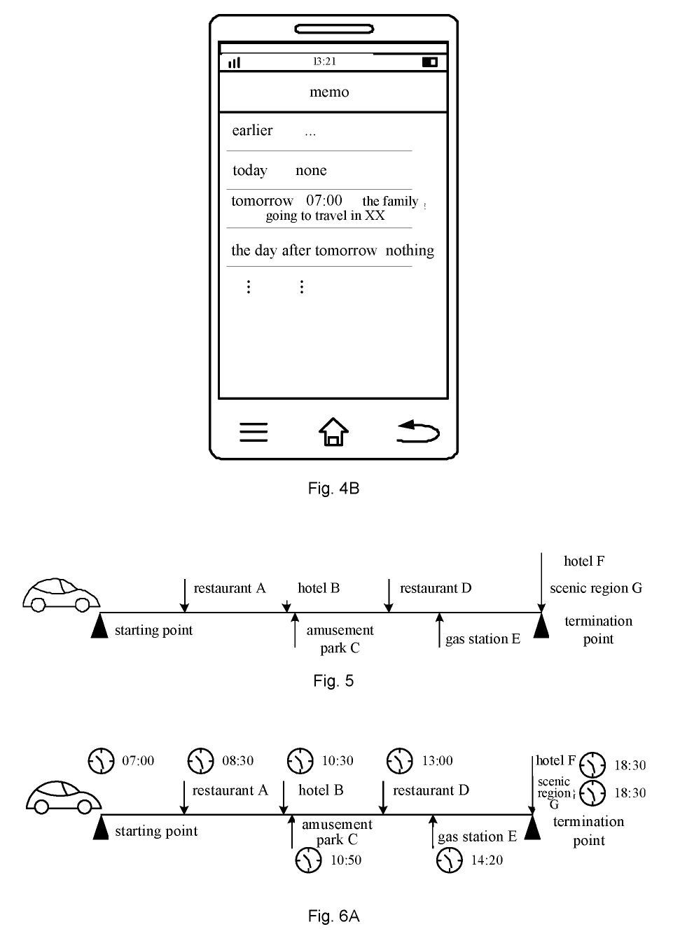

In some situations, a user may input the navigation information manually. As shown in FIG. 4A, the user may directly input pre-configured or customized items including a starting point, termination point, departing time, travel personnel, personnel relationship etc., and the electronic device may directly store these items, or generate and store information based on these items, as the navigation information.

In situations, the electronic device may extract and generate corresponding navigation information according to or based upon a memo, a calendar event, a travel plan, etc. created by the user. For example, as shown in FIG. 4B, assuming that the user's memo records that an event of “the family going to travel in XX” needs to be executed at “07:00” “tomorrow”, the electronic device may generate corresponding navigation information. In the generated corresponding navigation information, 7 o'clock tomorrow morning is configured as the departing time, the current location is configured as the starting point, and “XX” place is configured as the termination point. In addition, the electronic device may further analyze data, such as family composition of the user, based on behavior data, for example in terms of or based upon normal consumption, communication etc. of the user, such that information such as a total number of travel personnel and the personnel relationship may be further speculated about and associated with the user.

The device with which the user executes the input operation for data (such as the navigation information or the address book), may be an electronic device configured for the navigation operation. Alternatively or additionally, the user may choose any other device to input data (such as the above-described navigation information or the address book), and then execute a login operation on each device into a same user account, such that the electronic device configured for the navigation operation obtains the data (such as the navigation information or the address book) via a network that is configured to communicate with the various devices, access, process, store, and transmit data associated with the user account.

In step 304, all services are obtained via a pre-configured uniform service interface.

In the present embodiment, the uniform service interface may be accessible in advance to service providers (such as each merchant) via the navigation software, such that the service providers may provide, to the navigation software, data such as service description information about their services. The uniform service interface may include a server that receives, stores, and organizes information input by service providers and that is configured to receive requests from and communicate information to devices running the navigation software.

Then, the navigation software may obtain all of the services via the pre-configured uniform service interface and choose the service related to the navigation information from all of the services. All of the services may include all services stored by the server of the uniform service interface.

In step 306, the service related to the navigation information (i.e. the navigation-related service) is determined.

In some embodiments, the navigation information necessarily includes a navigation route. In some embodiments, the navigation information may further include other optional contents, etc. Based on differences of the contents of the navigation information, the navigation software may determine the service related to the navigation information according to different methods. Exemplary implementation embodiments of step 306 are explained according to several possible situations below.

### Embodiment 1

As an example embodiment, if the navigation information includes the navigation route, a service with a location for utilizing the service that is along the navigation route or at the termination point of the navigation route may be chosen.

As shown in FIG. 5, after the user defines a starting point and a termination point, the navigation software generates the corresponding navigation route. Then, by combining all of the services obtained in step 304 and the corresponding respective locations for utilizing the service, the service along the navigation route or at the termination point of the navigation route may be determined. For example, in FIG. 5, if the user does not change from the initially generated navigation route during the driving process, the navigation software estimates that restaurant A, hotel B, amusement park C, restaurant D, gas station E, hotel F and scenic region G etc. will be passed by successively. Of those service providers, restaurant A and restaurant D, etc. may provide services such as catering. Hotel B and hotel F, etc. may provide services such as accommodation. Amusement park C and scenic region G, etc. may provide services such as entertainment. Gas station E may provide services such as refuelling.

Therefore, the navigation software may determine that the services provided by the above-described service providers restaurant A through scenic region G, etc., which are located along the navigation route or at the termination point of the navigation route, are the services that the user may need, such that the services are regarded by the navigation software as the services related to the navigation information.

### Embodiment 2

As another example embodiment, the navigation information includes, for a plurality of services, a respective estimated time of arrival at a respective location for utilizing each service, in addition to including the navigation route. Then a service with a corresponding respective location for utilizing the service that is located along the navigation route or at the termination point of the navigation route may be chosen, for which a respective pre-estimated time of arrival at the respective location for utilizing the service is within a pre-determined service processing time period of the service.

Based on the determined navigation route, the navigation software may determine the pre-estimated time at which the user will arrive at the location for utilizing the service that is along the navigation route or at the termination point of the navigation route. This determination may be according to at least one of a mode of transportation used by the user, status information of the mode of transportation, or a traffic condition.

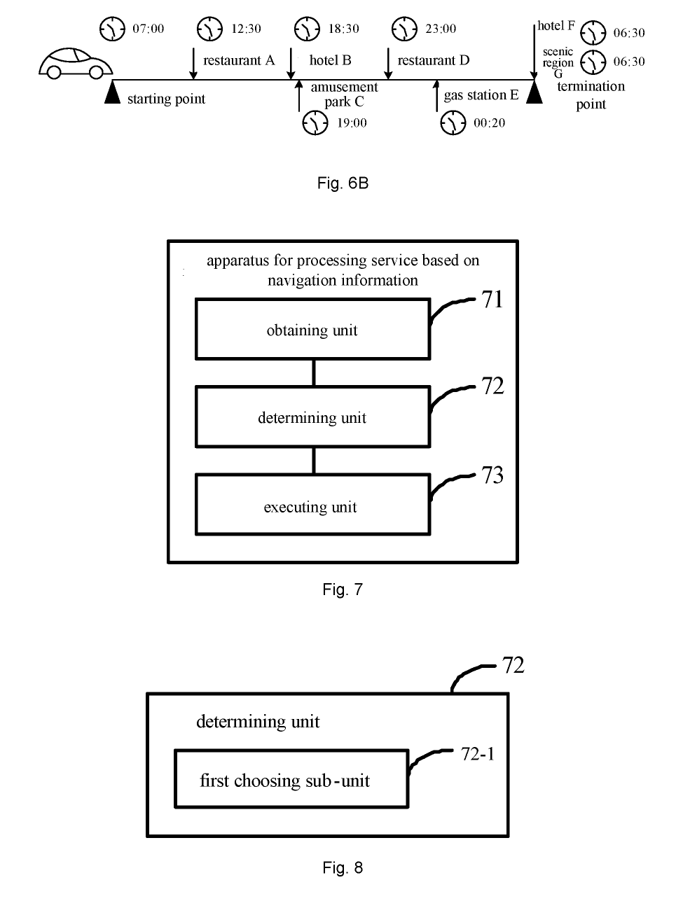

1) For example, as shown in FIG. 6A, assuming that the mode of transportation used by the user is a self-driven vehicle, i.e. a vehicle that is controlled by a driver, and traffic conditions are good, then when the user sets out at 07:00 from the starting point, the navigation software may estimate that the user will arrive at restaurant A at 08:20, arrive at restaurant B at 10:30, arrive at amusement park Cat 10:50, arrive at restaurant D at 13:00, arrive at gas station E at 14:00, arrive at hotel F, and arrive at scenic region G at 18:30.

(1) For a “catering” service, the pre-determined service processing time period is a normal time period for drinking and eating, such as 08:00-09:00 for breakfast, 12:00-13:30 for lunch, and 18:00-21:00 for dinner. Because the navigation software estimates that the user will arrive at restaurant A at 08:30, arrive at restaurant D at 13:00, and arrive at hotel F at 18:30, the navigation software may determine that the user will need a breakfast service provided by restaurant A, a lunch service provided by restaurant D, and a dinner service provided by hotel F. Accordingly, the navigation software may choose the catering services corresponding respectively to restaurant A, restaurant D, and hotel F, as the services related to the navigation information.

(2) For an “accommodation” service, the pre-determined service processing time period is a normal time period for accommodation, such as 18:00-06:00 (the next day). Because the navigation software estimates that the user will arrive at hotel B at 10:30 and arrive at hotel F at 18:30, the navigation software may determine that the user will need the accommodation service provided by hotel F rather than hotel B. Accordingly, the navigation software may choose the accommodation service corresponding to hotel F as the service related to the navigation information.

(3) For an “entertainment” service, the pre-determined service processing time period is a normal time period for entertainment, such as 09:00-20:00. Because the navigation software estimates that the user will arrive at amusement park C at 10:50 and arrive at scenic region G at 18:30, the navigation software may determine that the user will need the entertainment services provided respectively by amusement part C and scenic region G. Accordingly, the navigation software may choose the entertainment services corresponding respectively to amusement part C and scenic region G as the services related to the navigation information.

(4) For a “refueling” service, the pre-determined service processing time period is related to status information of the mode of transportation and the traffic conditions. For example, if a remaining amount of fuel in the tank of the user's vehicle can only support the user driving drive X kilometers in good traffic conditions, according to the user's driving habit, a speed-limit condition along the navigation route, and the traffic condition, etc., then the navigation software may estimate the driving time that the remaining amount of fuel in the tank can support. Thus the navigation software can determine the corresponding service processing time period for refueling service. In one example, the estimated driving time is 9 hours, and the user departs at 07:00, but the user will not be expected to arrive at the termination point by 16:00, which is when the navigation software estimates the fuel will be used up. Then the service processing time period may be determined by the navigation software as being a certain time period (which should be less than the pre-determined driving time 9 hours) prior to 16:00, such as the 3 hour period before 16:00. The estimated time of arrival at the gas station E (e.g. 14:00) may be determined by the navigation software to be within this service processing time period, and thus the refuelling service of gas station E should be regarded by the navigation software as the service related to the navigation information.

2) As shown in FIG. 6B, assuming that the mode of transportation used by the user is a self-driven vehicle, and the traffic condition is a traffic jam, then when the user sets out at 07:00 from the starting point, the navigation software may estimate that the user will arrive at restaurant A at 12:30, arrive at restaurant B at 18:30, arrive at amusement park C at 19:00, arrive at restaurant D at 23:00, arrive at gas station E at 00:20, arrive at hotel F, and arrive at scenic region G at 6:30. (1) For the “catering” service, the pre-determined service processing time period is a normal time period for drinking and eating, such as 08:00-09:00 for breakfast, 12:00-13:30 for lunch, and 18:00-21:00 for dinner. Because the navigation software estimates that the user will arrive at restaurant A at 12:30 and arrive at hotel B at 18:30, the navigation software may determine that the user will need a lunch service provided by restaurant A and a dinner service provided by hotel B. Accordingly the navigation software may choose the catering services corresponding respectively to restaurant A and hotel B as the services related to the navigation information.

(2) For an “accommodation” service, the pre-determined service processing time period is a normal time period for accommodation, such as 18:00-06:00 (the next day). Because the navigation software estimates that the user will arrive at hotel B at 18:30 and arrive at hotel F at 6:30, the navigation software may determine that the user will need the accommodation service provided by hotel B rather than hotel F. Accordingly the navigation software may choose the accommodation service corresponding to hotel B as the service related to the navigation information.

(3) For an “entertainment” service, the pre-determined service processing time period is a normal time period for entertainment, such as 09:00-20:00. Because the navigation software estimates that the user will arrive at amusement park C at 19:00 and arrive at scenic region G at 6:30, the navigation software may determine that the user will need the entertainment service provided by amusement park C rather than scenic region G. Accordingly navigation software may choose the entertainment service corresponding to amusement park C as the service related to the navigation information.

(4) For a “refueling” service, one example assumes that the estimated driving time is 9 hours, and the user departs at 07:00, but the user will not be expected to arrive at the termination point by 16:00, which is when the navigation software estimates the fuel will be used up. Then the service processing time period may be determined by the navigation software as being a certain time period (which should be less than the pre-determined driving time 9 hours) prior to 16:00, such as the 3 hour period before 16:00. However, since the user is estimated to arrive at the gas station E at 00:20, another gas station should be chosen by the navigation software as the service provider. The corresponding service processing time period may then be re-determined according to the remaining fuel after a refuelling before 16:00 has been completed in time at another gas station, such that the user may determine whether the gas station E is then configured as the service related to the navigation information.

### Embodiment 3

In yet another example embodiment, the navigation information includes user attribute information in a preset dimension, in addition to including the navigation route. A service with a respective location for utilizing the service that is located along the navigation route or at the termination point of the navigation route may be chosen, such that the service satisfies a user requirement corresponding to the user attribute information.

For example, a preset dimension may include at least one of a number of users, a user gender, a user age, or a user relationship. The preset dimension may also include other types, which shall not be limited to the examples herein.

Taking the “entertainment” service as an example, if the user attribute information indicates there is only an adult, although the services along the navigation route include the entertainment services provided by amusement park C and scenic region G, the adult will likely rather prefer to go to scenic region G rather than amusement park C. Therefore the entertainment service provided by scenic region G is chosen by the navigation software as the service related to the navigation information. If the user attribute information indicates that there are parents along with children, it is most likely that amusement park C is the preferred stop. Therefore, with the above differences in user attribute information, the navigation software may respectively choose the entertainment services provided by scenic region G and amusement park C as the services related to the navigation information.

In an aspect, in addition to factors of the “arriving time” in the above-described embodiment 2, and the “user attribute” in the embodiment 3, an appropriate service may also be chosen as the service related to the navigation information by combining optional contents of other types, which shall not be limited herein.

In another aspect, multiple optional contents in the navigation information may be applied by combining them with each other. For example, in the embodiment shown in FIG. 6A, although the user is estimated to arrive at amusement park C at 10:50, if the user attribute information indicates there is only an adult, it is most likely that the user will not choose to go to amusement park C, and therefore it is not required for the navigation software to regard the entertainment service provided by amusement park C as the service related to the navigation information.

In step 308, if the user is at an idle status, step 310 is executed, and if not, the method waits for a while before step 310 is executed.

In step 310, a service reminding operation is executed.

As an example embodiment, the navigation software may complete the pre-processing operation on the chosen service automatically, without attention or operation of the user.

As another example embodiment, the navigation software may complete the pre-processing operation on the chosen service automatically, and remind the user of the service related to the navigation information in step 310, such as by displaying a reminder on a screen of the electronic device, broadcasting a reminder through the electronic with speech, etc., such that the user may understand at an appropriate time the situation with respect to the service.

As yet another example embodiment, the navigation software may remind the user of the service related to the navigation information. The user may then send a selection instruction to the navigation software indicating whether or not to execute the pre-processing. Then the navigation software may determine, according to the received user selection instruction, whether or not to execute the pre-processing operation corresponding to the service. In this embodiment, due to the intervention of the user, inconvenience for the user and the service provider caused by an incorrect determination of the user's requirement for service may be avoided.

Alternatively, the service reminding operation for the user may be executed after determining that the user is at the idle status in step 308. For example, the navigation software may determine the user as being at the idle status when the user stops at a red light, takes a rest at a service area, or meets a traffic jam. The navigation software may determine whether the user is at the idle status by monitoring changes in the current location of the vehicle, for example based on location data received from a Global Positioning System (GPS). Executing the service reminding operation when the user is at the idle status can avoid the navigation software from affecting behaviours like the user's normal driving.

In step 312A, a reservation operation is executed.

As an example, the reservation operation for the service may be executed by the navigation software according to the navigation information. For example, when the service related to the navigation information is determined to be a catering service, a table may be reserved or food may be pre-ordered by the navigation software. For an accommodation service, a room may be reserved by the navigation software. For an entertainment service, tickets may be reserved, by the navigation software, etc. Due to the reservation operation, no additional operation is required to utilize the service after the user arrives. Additionally, a situation in which the corresponding service cannot be provided after the user arrives at the location for utilizing the service can be avoided. For example, by reserving the room according to the above method, a situation where there is no more room left in the hotel when the user arrives may be avoided.

In step 312B, the service provider is contacted.

As another example embodiment, the navigation software may send a notification message to a service provider, and the notification message may include the navigation information.

For example, when the navigation information includes a navigation route, the service provider may be alerted to a possible time of arrival of the user. This may allow the service provider to make preparations ahead of the time of arrival, so that after the user arrives at the location for utilizing the service, the service may be provided to the user as soon as possible.

For another example, the navigation information may include user attribute information, such as a number of users, a user gender, a user age, a user relationship etc. Then, the size of the table, the type of the room, the number of the tickets, etc., may be determined according to this user attribute information with regard to the catering service, the accommodation service, and the entertainment service etc.

Step 312A and step 312B only indicate two exemplary pre-processing methods, but all pre-processing operations related to utilizing the service may be realized through the technical solutions of the present disclosure, all of which shall not be elaborated herein. Pre-processing methods, including steps 312A and 312B, may be implemented by the navigation software communicating with the uniform service interface.

Corresponding to the above-described embodiments of the method of service processing based on the navigation information, the present disclosure also provides embodiments of an apparatus for service processing based on the navigation information.

FIG. 7 is a block diagram of an apparatus for service processing based on navigation information according to an example embodiment. Referring to FIG. 7, the apparatus for service processing includes an obtaining unit 71, a determining unit 72 and an executing unit 73.

The obtaining unit 71 is configured to obtain the navigation information.

The determining unit 72 is configured to determine a service related to the navigation information.

The executing unit 73 is configured to execute a pre-processing operation related to the service before arriving at a location for utilizing the service.

FIG. 8 is a block diagram of another apparatus for service processing based on navigation information according to an example embodiment, which is based on the above-described embodiment shown in FIG. 7. In the embodiment shown in FIG. 8, the navigation information includes a navigation route, and the determining unit 72 includes a first choosing sub-unit 72-1.

The first choosing sub-unit 72-1 is configured to choose a service with location for execution that is along the navigation route or at a termination point of the navigation route.

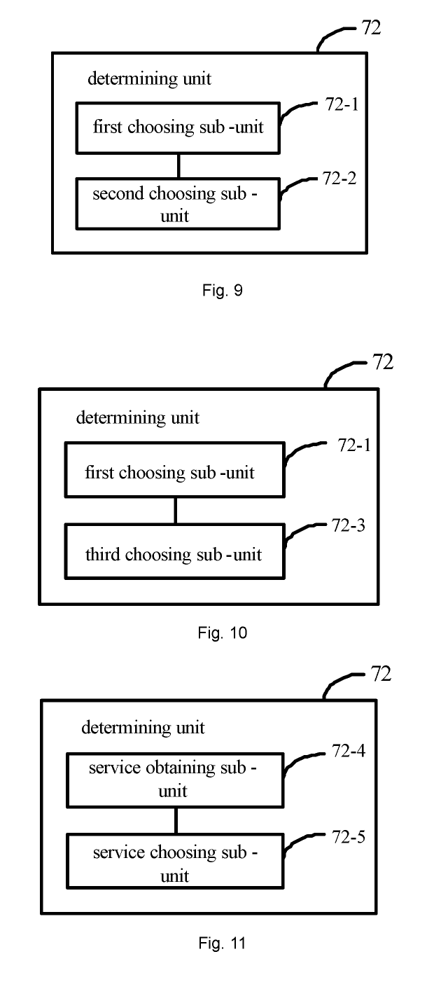

FIG. 9 is a block diagram of another apparatus for service processing based on navigation information according to an example embodiment, which is based on the above-described embodiment shown in FIG. 8. In the embodiment shown in FIG. 9, the navigation information further includes, for a plurality of services, a pre-estimated time of arrival at a respective location for utilizing each service. In the embodiment shown in FIG. 9, the determining unit 72 includes a second choosing sub-unit 72-2.

The second choosing sub-unit 72-2 is configured to choose a service with a location for utilizing the service that is along the navigation route or at the termination point of the navigation route, and for which the pre-estimated time of arrival at the respective location for utilizing the service is within a pre-determined service processing time period of the service.

Alternatively, the pre-estimated time is related to at least one of a mode of transportation used by a user, status information of the mode of transportation, or a traffic condition.

FIG. 10 is a block diagram of another apparatus for service processing based on navigation information according to an example embodiment, which is based on the above-described embodiment shown in FIG. 8. In the embodiment shown in FIG. 10, the navigation information further includes user attribute information in a preset dimension, and the determining unit 72 includes a third choosing sub-unit 72-3.

The third choosing sub-unit 72-3 is configured to choose a service with a respective location for utilizing the service that is along the navigation route or at the termination point of the navigation route, and that satisfies a user requirement corresponding to the user attribute information.

Alternatively, the preset dimension includes at least one of a number of users, a user gender, a user age, or a user relationship.

FIG. 11 is a block diagram of another apparatus for service processing based on navigation information according to an example embodiment, which is based on the above-described embodiment shown in FIG. 7. In the embodiment shown in FIG. 11, the determining unit 72 includes a service obtaining sub-unit 72-4 and a service choosing sub-unit 72-5.

The service obtaining sub-unit 72-4 is configured to obtain all services via a pre-configured uniform service interface.

The service choosing sub-unit 72-5 is configured to choose, from the obtained services, a service related to the navigation information.

The structures of the service obtaining sub-unit 72-4 and the service choosing sub-unit 72-5 shown in the apparatus embodiment of FIG. 11 may also be included in the apparatus embodiments of the above-described FIGS. 8-10, according to implementations which shall not be further elaborated herein.

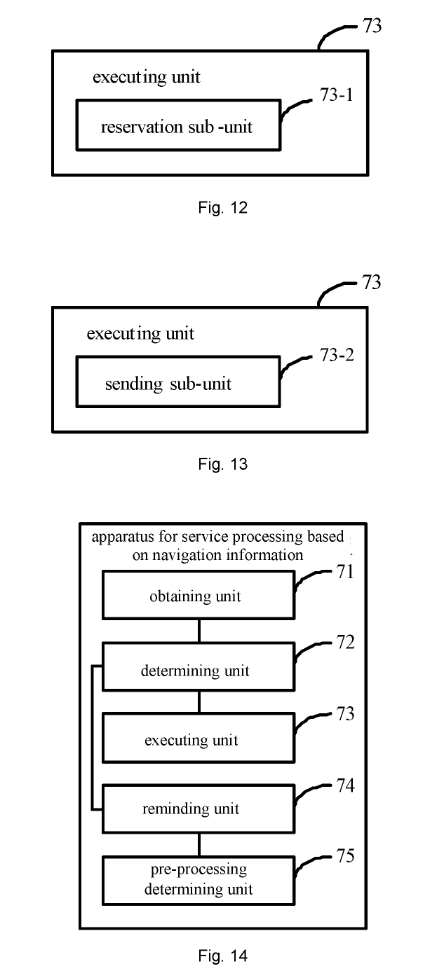

FIG. 12 is a block diagram of another apparatus for service processing based on navigation information according to an example embodiment, which is based on the above-described embodiment shown in FIG. 7. In the embodiment shown in FIG. 12, the executing unit 73 includes a reservation sub-unit 73-1.

The reservation sub-unit 73-1 is configured to execute a reservation operation for the service according to the navigation information.

The structure of the reservation sub-unit 73-1 shown in the apparatus embodiment of FIG. 12 may also be included in the apparatus embodiments of the above-described FIGS. 8-11, according to implementations which shall not be further elaborated herein.

FIG. 13 is a block diagram of another apparatus for service processing based on navigation information according to an example embodiment, which is based on the above-described embodiment shown in FIG. 7. In the embodiment shown in FIG. 13, the executing unit 73 includes a sending sub-unit 73-2.

The sending sub-unit 73-2 is configured to send a notification message to a service provider, the sent notification message including the navigation information.

The structure of the sending sub-unit 73-2 shown in the apparatus embodiment of FIG. 13 may also be included in the apparatus embodiments of the above-described FIGS. 8-11, according to implementations which shall not be further elaborated herein.

FIG. 14 is a block diagram of another apparatus for service processing based on navigation information according to an example embodiment, which is based on the above-described embodiment shown in FIG. 7. In the embodiment shown in FIG. 14, the apparatus for service processing further includes a reminding unit 74 and a pre-processing determining unit 75.

The reminding unit 74 is configured to remind a user of the service related to the navigation information.

The pre-processing determining unit 75 is configured to determine, according to a received user selection instruction, whether or not to execute the pre-processing operation.

The structures of the reminding unit 74 and the pre-processing determining unit 75 shown in the apparatus embodiment of FIG. 14 may also be included in the apparatus embodiments of the above-described FIGS. 8-13, according to implementations which shall not be further elaborated herein.

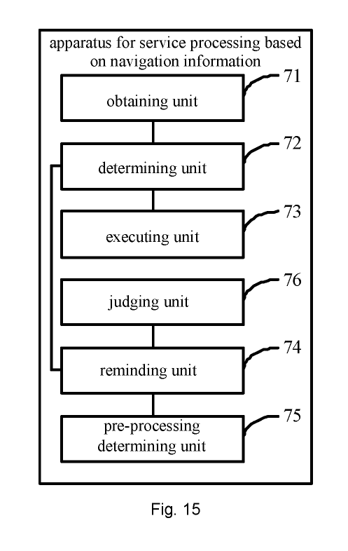

FIG. 15 is a block diagram of another apparatus for service processing based on navigation information according to an example embodiment, which based on the above-described embodiment shown in FIG. 14. In the embodiment shown in FIG. 14, the service processing apparatus further includes a judging unit 76.

The judging unit 76 is configured to determine whether the user is at a pre-determined idle status. The apparatus is configured to, when the user is determined to be at the pre-determined idle status, remind the user of the service related to the navigation information.

With respect to the apparatus(es) in the above embodiments, the specific operation modes of individual modules therein have been described in detail in the embodiments regarding the corresponding methods of service processing, and will not be further elaborated herein.

Because apparatus embodiments substantially correspond to service processing method embodiments, related corresponding aspects may be understood with reference to descriptions of those aspects in the service processing method embodiments. The apparatus embodiments described above are only exemplary. Modules illustrated as separate components may be or may not be physically separated from each other. Components represented as modules may be or may not be physical modules. Components depicted as being connected may be located in a same place or may be distributed in multiple network units. Some or all of the modules may be selected and combined according to the actual requirements of the user, so as to achieve objectives of the present disclosure, implementations of which may be understood or implemented by those skilled in the art without creative work.

An apparatus for service processing apparatus on navigation information is also provided in the present disclosure. In some embodiments, a device includes a processor and a memory configured to store instructions executable by the processor. The processor is configured to obtain the navigation information; determine a service related to the navigation information; and execute a pre-processing operation related to the service before arriving at a location for utilizing the service.

A terminal is also provided in the present disclosure. In some embodiments, the terminal includes a memory and one or more programs stored in the memory. The one or more programs are configured to include instructions executable by one or more processors to: obtain the navigation information; determine a service related to the navigation information; and execute a pre-processing operation related to the service before arriving at a location for utilizing the service.

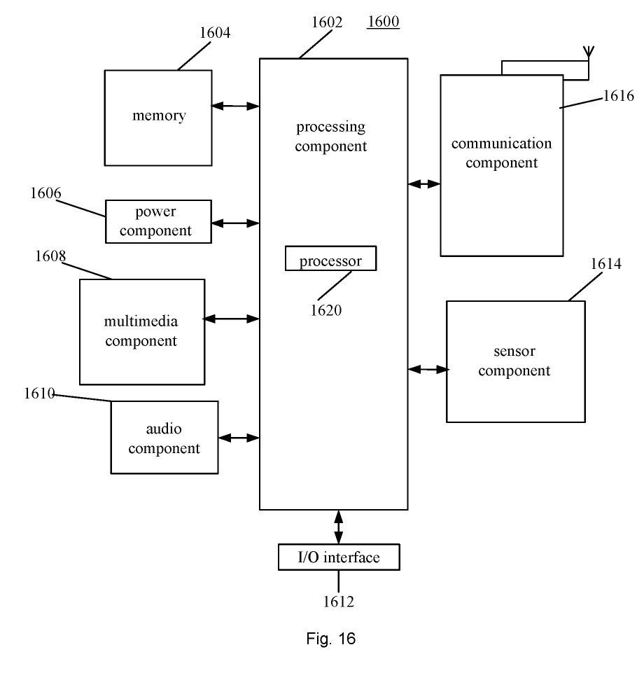

FIG. 16 is a schematic diagram of a device 1600 for processing a service based on navigation information according to an example embodiment. For example, the device 1600 may be a mobile phone, a computer, a digital broadcasting terminal, a messaging device, a game console, a tablet device, a medical device, a piece of exercise equipment, a personal digital assistant, etc.

Referring to FIG. 16, the device 1600 may include one or more of following components: a processing component 1602, a memory 1604, a power component 1606, a multimedia component 1608, an audio component 1610, an input/output (I/O) interface 1612, a sensor component 1614, and a communication component 1616.

The processing component 1602 typically controls overall operations of the device 1600, such as the operations associated with display, telephone calls, data communications, camera operations, and recording operations. The processing component 1602 may include one or more processors 1620 to execute instructions to perform all or part of the steps in the above described methods. Moreover, the processing component 1602 may include one or more modules which facilitate the interaction between the processing component 1602 and other components. For instance, the processing component 1602 may include a multimedia module to facilitate the interaction between the multimedia component 1608 and the processing component 1602.

The memory 1604 is configured to store various types of data to support the operation of the device 1600. Examples of such data include instructions for any applications or methods operated on the device 1600, contact data, phonebook data, messages, pictures, video, etc. The memory 1604 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1606 provides power to various components of the device 1600. The power component 1606 may include a power management system, one or more power sources, and any other components associated with the generation, management, and distribution of power in the device 1600.

The multimedia component 1608 includes a screen providing an output interface between the device 1600 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and other gestures on the touch panel. The touch sensors may not only sense a boundary of a touch or swipe action, but also sense a duration time and a pressure associated with the touch or swipe action. In some embodiments, the multimedia component 1608 includes a front camera and/or a rear camera. The front camera and the rear camera may receive external multimedia data while the device 1600 is in an operation mode, such as a photographing mode or a video mode. Each of the front camera and the rear camera may be a fixed optical lens system or have focus and optical zoom capability.

The audio component 1610 is configured to output and/or input audio signals. For example, the audio component 1610 includes a microphone (MIC) configured to receive an external audio signal when the device 1600 is in an operation mode, such as a call mode, a recording mode, and a voice recognition mode. The received audio signal may be further stored in the memory 1604 or transmitted via the communication component 1616. In some embodiments, the audio component 1610 further includes a speaker to output audio signals.

The I/O interface 1612 provides an interface between the processing component 1602 and peripheral interface modules, such as a keyboard, a click wheel, buttons, and the like. The buttons may include, but are not limited to, a home button, a volume button, a starting button, and a locking button.

The sensor component 1614 includes one or more sensors to provide status assessments of various aspects of the device 1600. For instance, the sensor component 1614 may detect an open/closed status of the device 1600 and relative positioning of components (e.g., the display and the keypad of the device 1600). The sensor component 1614 may also detect a change in position of the device 1600 or of a component in the device 1600, a presence or absence of user contact with the device 1600, an orientation or an acceleration/deceleration of the device 1600, and a change in temperature of the device 1600. The sensor component 1614 may include a proximity sensor configured to detect the presence of nearby objects without any physical contact. The sensor component 1614 may also include a light sensor, such as a CMOS or CCD image sensor, for use in imaging applications. In some embodiments, the sensor component 1614 may also include an accelerometer sensor, a gyroscope sensor, a magnetic sensor, a pressure sensor, or a temperature sensor.

The communication component 1616 is configured to facilitate wired or wireless communication between the device 1600 and other devices. The device 1600 can access a wireless network based on a communication standard, such as WIFI, 2G, or 3G, or a combination thereof. In one exemplary embodiment, the communication component 1616 receives a broadcast signal or broadcast associated information from an external broadcast management system via a broadcast channel. In one exemplary embodiment, the communication component 1616 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the device 1600 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as the memory 1604 including instructions. The above instructions are executable by the one or more processors 1620 in the device 1600, for performing the above-described methods. For example, the non-transitory computer-readable storage medium may be a ROM, a RAM, a CD-ROM, a magnetic tape, a floppy disc, an optical data storage device, and the like.

The methods, devices, modules, and units described above may be implemented in many different ways and as hardware, software or in different combinations of hardware and software. For example, all or parts of the implementations may be a processing circuitry that includes an instruction processor, such as a central processing unit (CPU), microcontroller, a microprocessor; or application specific integrated circuits (ASICs), digital signal processors (DSPs), digital signal processing devices (DSPDs), programmable logic devices (PLDs), field programmable gate arrays (FPGAs), controllers, micro-controllers, microprocessors, other electronic components; or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

Each module, unit, or sub-unit discussed above, such as the obtaining unit 71, determining unit 72, executing unit 73, first choosing sub-unit 72-1, second choosing sub-unit 72-2, third choosing sub-unit 72-3, service obtaining sub-unit 72-4, service choosing sub-unit 72-5, reservation sub-unit 73-1, sending sub-unit 73-2, reminding unit 74, pre-processing determining unit 75, and/or judging unit 76, may take the form of a packaged functional hardware unit designed for use with other components, a portion of a program code (e.g., software or firmware) executable by the one or more processors 1620 or the processing circuitry that usually performs a particular function of related functions, or a self-contained hardware or software component that interfaces with a larger system, for example. Each module, unit, or sub-unit discussed above may be configured to operate according to algorithms specified in the descriptions of method steps discussed above, including step 202, step 204, step 206, step 302, step 304, step 306, step 308, step 310, step 312A, and step 312B.

Other embodiments of the disclosure will be apparent to those skilled in the art from consideration of the specification and practice of the disclosure disclosed here. This application is intended to cover any variations, uses, or adaptations of the disclosure following the general principles thereof and including such departures from the present disclosure as come within known or customary practice in the art. It is intended that the specification and examples be considered as exemplary only, with a true scope and spirit of the disclosure being indicated by the following claims.

It will be appreciated that the present disclosure is not limited to the exact construction that has been described above and illustrated in the accompanying drawings, and that various modifications and changes can be made without departing from the scope thereof. It is intended that the scope of the disclosure only be limited by the appended claims.

What is claimed is:

1. A method of service processing based on navigation information, comprising:
obtaining, with a processor, the navigation information;
determining, by the processor, a service related to the navigation information; and
executing, by the processor, a pre-processing operation related to the service before arriving at a location for utilizing the service.

2. The method of claim 1, wherein:
the navigation information comprises a navigation route; and
determining the service related to the navigation information comprises choosing the service with a location for utilizing the service that is along the navigation route or at a termination point of the navigation route.

3. The method of claim 2, wherein:
the navigation information further comprises, for a plurality of services, a respective pre-estimated time of arrival at a respective location for utilizing each service; and
determining the service related to the navigation information comprises choosing, from the plurality of services, the service:
having a respective location for utilizing the service that is along the navigation route or at the termination point of the navigation route, and
for which a respective pre-estimated time of arrival at the respective location for utilizing the service is within a pre-determined service processing time period of the service.

4. The method of claim 3, wherein a pre-estimated time of arrival at the location for utilizing the service is related to at least one of a mode of transportation used by a user, status information of the mode of transportation, or a traffic condition.

5. The method of claim 2, wherein:
the navigation information further comprises user attribute information in a preset dimension; and
determining the service related to the navigation information comprises choosing the service:
having a respective location for utilizing the service that is along the navigation route or at the termination point of the navigation route, and
that satisfies a user requirement corresponding to the user attribute information.

6. The method of claim 5, wherein the preset dimension comprises at least one of a number of users, a user gender, a user age, or a user relationship.

7. The method of claim 1, wherein determining the service related to the navigation information comprises:
obtaining all services via a pre-configured uniform service interface; and
choosing, from the obtained services, the service related to the navigation information.

8. The method of claim 1, wherein executing the pre-processing operation related to the service comprises executing a reservation operation for the service according to the navigation information.

9. The method of claim 1, wherein executing the pre-processing operation related to the service comprises sending a notification message to a service provider, wherein the notification message comprises the navigation information.

10. The method of claim 1, further comprising:
reminding a user of the service related to the navigation information; and
determining, according to a received user selection instruction, whether or not to execute the pre-processing operation.

11. The method of claim 10, further comprising:
determining whether the user is at a pre-determined idle status; and
when the user is determined to be at the pre-determined idle status, reminding the user of the service related to the navigation information.

12. An apparatus for service processing based on navigation information, comprising:
a processor; and
a memory configured to store instructions executable by the processor;
wherein the processor is configured to:
obtain the navigation information;
determine a service related to the navigation information; and
execute a pre-processing operation related to the service before arriving at a location for utilizing the service.

13. The apparatus of claim 12, wherein:
the navigation information comprises a navigation route; and
wherein to determine the service related to the navigation information the processor is configured to choose the service with a location for utilizing the service that is along the navigation route or at a termination point of the navigation route.

14. The apparatus of claim 13, wherein:
the navigation information further comprises, for a plurality of services, a respective pre-estimated time of arrival at a respective location for utilizing each service; and
the processor is configured to determine the service related to the navigation information by choosing, from the plurality of services, the service:
having a respective location for utilizing the service that is along the navigation route or at the termination point of the navigation route, and
for which a respective pre-estimated time of arrival at the respective location for utilizing the service is within a pre-determined service processing time period of the service.

15. The apparatus of claim 13, wherein:
the navigation information further comprises user attribute information in a preset dimension; and
the processor is configured to determine the service related to the navigation information by choosing the service:
having a respective location for utilizing the service that is along the navigation route or at the termination point of the navigation route, and
that satisfies a user requirement corresponding to the user attribute information.

16. The apparatus of claim 12, wherein the processor is configured to determine the service related to the navigation information by:
obtaining all services via a pre-configured uniform service interface; and
choosing, from the obtained services, the service related to the navigation information.

17. The apparatus of claim 12, wherein, the processor is configured to execute the pre-processing operation related to the service by executing a reservation operation for the service according to the navigation information.

18. The apparatus of claim 12, wherein the processor is configured to execute the pre-processing operation related to the service by sending a notification message to a service provider, wherein the notification message comprises the navigation information.

19. The apparatus of claim 12, wherein the processor is further configured to:
remind a user of the service related to the navigation information; and
determine, according to a received user selection instruction, whether or not to execute the pre-processing operation.

20. The apparatus of claim 20, wherein the processor is further configured to:
determine whether the user is at a pre-determined idle status; and
when the user is determined to be at the pre-determined idle status, remind the user of the service related to the navigation information.
